(19) United States
(12) Patent Application Publication
(10) Pub. No.: US 2008/0095461 A1
(43) Pub. Date: Apr. 24, 2008

(54) Apparatus and method for determining filter condition area in deblocking filter

(75) Inventors: Han-Sang Kim, Suwon-si (KR); Chan-Yul Kim, Bucheon-si (KR); Kwang-Pyo Choi, Anyang-si (KR); Yun-Je Oh, Yongin-si (KR); Young-Hun Joo, Yongin-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/900,279

(22) Filed: Sep. 10, 2007

(30) Foreign Application Priority Data
Oct. 20, 2006 (KR) 102297 /2006

(51) Int. Cl. G06K 9/40

(52) U.S. Cl. 382/268

(57) ABSTRACT

An apparatus for calculating a boundary strength on a macroblock basis to determine a filter condition area in a deblocking filter includes a memory unit for storing a table containing a filter condition area value for a boundary strength calculation, which correspond to each of a type value of a current macroblock and a type value of a neighbor macroblock, and storing a boundary strength calculation method per filter condition area, the deblocking filter for performing the boundary strength calculation according to a filter condition area with respect to an input macroblock, and a controller for determining a filter condition area value corresponding to a type value of a current macroblock input to the deblocking filter and a type value of its neighbor macroblock using the table when the boundary strength calculation is performed with respect to the current macroblock input to the deblocking filter.

### CLAIMS OF PRIORITY

This application claims the benefit under 35 U.S.C. §119(a) of a Patent Application filed in the Korean Intellectual Property Office on Oct. 20, 2006 and assigned Serial No. 2006-102297, the entire disclosure of which is hereby incorporated by reference.

### BACKGROUND OF THE INVENTION

1. Field of the Invention

The present invention relates generally to a deblocking filter used for a standard video codec, and in particular, to an apparatus and method for quickly calculating a boundary strength on a macroblock basis to determine a filter condition area in a deblocking filter.

2. Description of the Related Art

Most image processing systems use image data compressed using a standard video codec. Video codecs generally used are codecs recommended by the International Telecommunication Union (ITU), such as H.261, H.262, and H.263, and codecs recommended by Motion Picture Experts Group (MPEG), such as MPEG-1, MPEG-2, and MPEG-4. Recently, the study and standardization of an H.264 video codec for implementing a higher compression ratio has progressed rapidly.

Coded image data is decoded to original image data by means of a separate decoding process in an image processing device and displayed on a screen. In general, a video decoder system includes a context analyzer, a plurality of hardware modules for decoding coded image data, a memory, and peripherals (a Direct Memory Access (DMA) device, etc.). These components together perform data transmission with each other via a bus. A plurality of hardware modules for decoding is, for example, an entropy decoder, an inverse transformer, a predictor, and a deblocking filter. Coded image data is sequentially processed by the plurality of hardware modules and decoded to original image data. In the decoding process, each hardware module reads necessary data or stores processed data by accessing an external memory or an internal memory, including Static Random Access Memory (SRAM), as necessary.

Image data is compressed on a macroblock basis, and when the compressed image data is decompressed, a blocking effect occurs that results in a difference between images in a block unit. This blocking effect is due to a discontinuity of image data values or slopes in a boundary area between blocks of the decompressed image data. Since the blocking effect appears as a rectangular grating pattern along a boundary between blocks, it can be easily recognized and results in a decrease of subjective image quality. Thus, a deblocking process is performed in order to reduce this blocking effect, and a hardware module for performing the deblocking process is the deblocking filter.

The deblocking filter selects an edge of an image for which a filtering calculation is performed, reads pixel data of the selected edge from the external or internal memory, and stores the pixel data in a register array in the deblocking filter. The deblocking filter restores the edge part of the image and determines a filtering strength of a boundary filter so that excessive filtering does not occur. The deblocking filter finally determines by comparing the filtering strength to a threshold value whether filtering is to be performed. If it is determined that filtering is to be performed, the deblocking filter performs filtering using the pixel data of the selected edge, which has been stored in the register array, and outputs pixels for which the filtering has been completed. An algorithm of the deblocking process is disclosed in detail in an H.264/Advanced Video Coding (AVC) standardization document.

Since it can be seen that the deblocking effect occurs because image data is compressed on a macroblock basis, edge filtering in the deblocking filter is also performed on a macroblock basis. Referring to FIG. 1 in order to describe a filtering calculation of a single macroblock, when the filtering calculation of a current macroblock (MB) is performed, a MB B located on the top of the current MB and a MB A located on the left of the current MB are used. That is, in order to perform edge filtering of the current MB, data of the MB B and the MB A is required.

When the deblocking filter determines the boundary strength, the boundary strength is differently calculated according to a type of a neighbor MB with respect to a current MB, wherein specific type values of a MB are defined as in Table 1.

In Table 1, the MB type can be classified into “skip”, “inter”, and “intra”. Based on the MB type, the current MB and the neighbor MB correspond to one of four areas illustrated in FIG. 2 according to type values thereof.

TABLE 1
MB type

| | |
|---|---|
| #define MB_SKIP | 0 |
| #define MB_P_16 × 16 | 1 |
| #define MB_P_16 × 8 | 2 |
| #define MB_P_8 × 16 | 3 |
| #define MB_P_8 × 8 | 4 |
| #define MB_P_8 × 8ref0 | 9 |
| #define MB_I_4 × 4 | 10 |
| #define MB_I_16 × 16 | 11 |
| #define MB_I_PCM | 35 |

Referring to FIG. 2, if both MB types of the current MB and the neighbor MB are ‘skip’, the current MB and the neighbor MB correspond to a first area, and if both MB types of the current MB and the neighbor MB are ‘inter’ or one of them is ‘skip’ and the other is ‘inter’, the current MB and the neighbor MB correspond to a second area, and if a MB type of the current MB is ‘intra’, the current MB and the neighbor MB correspond to a third area, and if a MB type of the neighbor MB is ‘intra’ and a MB type of the current MB is not ‘intra’, the current MB and the neighbor MB correspond to a fourth area. According to an area determined as just described, a different boundary strength calculation method is set, and the boundary strength is determined using the set boundary strength calculation method.

That is, as described above, according to type values of a current MB and a neighbor MB, one of the four areas illustrated in FIG. 2 is determined, and the boundary strength is calculated using a boundary strength calculation method corresponding to the determined area.

Two methods are used to determine an area for the boundary strength calculation with respect to a current MB, which are illustrated in FIGS. 3 and 4. FIG. 3A is a code fragment of the first method and corresponds to FIG. 3b

Conditions to determine an area in the area determination using the first method and the number of cycles occurring for the boundary strength calculation according to comparison of the conditions will now be described with reference to FIGS. 2, 3A, and 3B. The conditions to determine an area in the area determination are as follows:

1. It is first determined whether a type value of a current MB is less than 10 which is the type value of “#define MB_I_{—}4×4”, and when a case where it is determined that the type value of the current MB is less than 10 that is the type value of “#define MB_I_{—}4×4”,

(1) It is determined whether a type value of a neighbor MB is equal to or greater than 10 that is the type value of “#define MB_I_{—}4×4”, and a case where it is determined that the type value of the neighbor MB is equal to or greater than 10 that is the type value of “#define MB_I_{—}4×4”,

(2) If it is determined that the type value of the neighbor MB is less than 10 that is the type value of “#define MB_I_{—}4×4”, it is determined whether the current MB corresponds to “#define MB_SKIP” and whether the neighbor MB corresponds to “#define MB_SKIP”, and a case where it is not determined that both the current MB and the neighbor MB correspond to “#define MB_SKIP”,

(3) It is determined whether the current MB corresponds to “#define MB_SKIP” and whether the neighbor MB corresponds to “#define MB_SKIP”, and a case where it is determined that both the current MB and the neighbor MB correspond to “#define MB_SKIP”, and

2. A case where it is determined that the type value of the current MB is equal to or greater than 10 that is the type value of “#define MB_I_{—}4×4”.

Using the first method, if the condition 1→(1) is satisfied from among the conditions to determine an area in the area determination, it can be seen that the current MB and the neighbor MB correspond to the fourth area. In this case, in order to determine the fourth area, the condition comparison process is performed twice.

If the condition 1→(2) is satisfied from among the conditions to determine an area in the area determination, it can be seen that the current MB and the neighbor MB correspond to the second area. In this case, in order to determine the second area, the condition comparison process is performed five times.

If the condition 1→(3) is satisfied from among the conditions to determine an area in the area determination, it can be seen that the current MB and the neighbor MB correspond to the first area. In this case, in order to determine the first area, the condition comparison process is performed eight times.

If the condition 1 is not satisfied, the condition 2 is satisfied, and thus, it can be seen that the current MB and the neighbor MB correspond to the third area. In this case, in order to determine the third area, the condition comparison process is performed once.

As described above, a mean number of cycles occurring for the boundary strength calculation according to the condition comparison in the first method can be calculated using Formula 1. Here, the mean number of cycles can be predicted according to weights of areas illustrated in FIG. 5. Referring to FIG. 5, among the weights of the first to fourth areas illustrated in FIG. 2, the second and first areas respectively occupy 64% and 27%, a sum being 97% of the total weight.

$$\begin{matrix}mean number of cycles = 0.27 * 8 + 0.64 * 5 + 0.07 * 1 + 0.02 * 2 \\ = 2.16 + 3.2 + 0.07 + 0.04 \\ = 5.47\end{matrix} \qquad ( 1 )$$

Conditions to determine an area in the area determination using the second method and the number of cycles occurring for the boundary strength calculation according to comparison of the conditions will now be described with reference to FIGS. 2, 4A, and 4B. The conditions to determine an area in the area determination are as follows:

1. It is determined whether a type value of a current MB is less than 10 that is the type value of “#define MB_I_{—}4×4” and whether a type value of a neighbor MB is less than 10 that is the type value of “#define MB_I_{—}4×4”, it is determined whether both the type value of the current MB and the type value of the neighbor MB are less than 10 that is the type value of “#define MB_I_{—}4×4”, and a case where it is determined that both the type values are less than 10, that is the type value of “#define MB_I_{—}4×4”,

(1) It is determined whether the type value of the current MB is greater than 1 that is the type value of “#define MB_SKIP” and whether the type value of the neighbor MB is greater than 1 that is the type value of “#define MB_SKIP”, it is determined whether both the type value of the current MB and the type value of the neighbor MB are greater than 1 that is the type value of “#define MB_SKIP”, and a case where it is determined that any one of both the type value of the current MB and the type value of the neighbor MB are greater is greater than 1 that is the type value of “#define MB SKIP”,

(2) A case where both the current MB and the neighbor MB correspond to “#define MB_SKIP”

2. It is determined whether the type value of the current MB is less than 10 that is the type value of “#define MB_I_{—}4×4” and whether a type value of a neighbor MB is less than 10 that is the type value of “#define MB_I_{—}4×4”, it is determined whether both the type value of the current MB and the type value of the neighbor MB are less than 10 that is the type value of “#define MB_I_{—}4×4”, and a case where it is determined that the type value of the current MB is equal to or greater than 10 that is the type value of “#define MB_I_{—}4×4”, and

3. It is determined whether the type value of the current MB is less than 10 that is the type value of “#define MB_I_{—}4×4” and whether a type value of a neighbor MB is less than 10 that is the type value of “#define MB_I_{—}4×4”, it is determined whether both the type value of the current MB and the type value of the neighbor MB are less than 10 that is the type value of “#define MB_I_{—}4×4”, and a case where it is determined that the type value of the neighbor MB is equal to or greater than 10 that is the type value of “#define MB_I_{—}4×4” and the type value of the current MB is less than 10 that is the type value of “#define MB_I_{—}4×4”.

Using the second method, if the condition 1→(1) is satisfied from among the conditions to determine an area in the area determination, it can be seen that the current MB and the neighbor MB correspond to the second area. In this case, in order to determine the second area, the condition comparison process is performed six times.

If the condition 1→(2) is satisfied from among the conditions to determine an area in the area determination, it can be seen that the current MB and the neighbor MB correspond to the first area. In this case, in order to determine the first area, the condition comparison process is performed six times.

If the condition 2 is satisfied without satisfying the condition 1 from among the conditions to determine an area in the area determination, it can be seen that the current MB and the neighbor MB correspond to the third area. In this case, in order to determine the third area, the condition comparison process is performed four times.

If the condition 3 is satisfied without satisfying the conditions 1 and 2, it can be seen that the current MB and the neighbor MB correspond to the fourth area. In this case, in order to determine the fourth area, the condition comparison process is performed four times.

As described above, a mean number of cycles occurring for the boundary strength calculation according to the condition comparison in the second method can be calculated using Formula 2. Here, the mean number of cycles can be predicted according to the weights of areas illustrated in FIG. 5.

$$\begin{matrix}mean number of cycles = 0.27 * 6 + 0.64 * 6 + 0.07 * 4 + 0.02 * 4 \\ = 1.62 + 3.84 + 0.28 + 0.08 \\ = 5.47\end{matrix} \qquad ( 2 )$$

As described above, by performing the condition comparison process on a MB basis at least once and at most six times, it can be known in order to calculate a boundary strength value which area a current MB belongs to.

Referring to Formulas 1 and 2, around five cycles are needed to calculate the boundary strength of a single MB. That is, when a picture size is a Quarter Video Graphic Array (QVGA), since the boundary strength calculation is performed in both vertical and horizontal directions, 1641*2˜1746*2 cycles are needed to decode a single frame.

As described above, according to the mean number of cycles occurring for the boundary strength calculation in the deblocking filter, by performing the condition comparison process on a MB basis at least once at most eight times, it can be known in order to calculate a boundary strength value which area a current MB belongs to. If the number of cycles required to perform a filtering calculation with respect to a single MB is larger, it may be difficult to process an image in real-time.

### SUMMARY OF THE INVENTION

The present invention provides an apparatus and method for processing an image in real-time by maximally reducing the number of cycles required for a boundary strength calculation with respect to a single macroblock in a deblocking filter.

The present invention provides an apparatus for determining a filter condition area in a deblocking filter, the apparatus comprising: a memory unit for storing a table containing a plurality of filter condition area values for a boundary strength calculation, which includes values that correspond to each of a type value of a current macroblock and a type value of a neighbor macroblock, and storing a boundary strength calculation method per filter condition area; the deblocking filter for performing the boundary strength calculation according to a filter condition area with respect to an input macroblock; and a controller for determining a filter condition area value corresponding to a type value of a current macroblock input to the deblocking filter and a type value of a neighbor macroblock using the filter condition area values of the table when the boundary strength calculation is performed with respect to the current macroblock input to the deblocking filter and controlling a filtering operation of the deblocking filter according to the determined filter condition area value.

The present invention also provides an apparatus for determining a filter condition area in a deblocking filter, the apparatus comprising: a memory unit for storing a table containing a plurality of filter condition area values for a boundary strength calculation, which corresponds to each of a plurality of type values including at least one type value of a current macroblock and at least one of a type value of a neighbor macroblock, storing a state diagram of areas, which indicates an area according to a type of the current macroblock and a type of the neighbor macroblock, and storing a boundary strength calculation method per filter condition area; the deblocking filter for performing the boundary strength calculation according to a filter condition area with respect to an input macroblock; and a controller for determining a filter condition area value by determining a filter condition area value according to a type value of a current macroblock input to the deblocking filter and a type value of its neighbor macroblock using the table when the boundary strength calculation is performed with respect to the current macroblock input to the deblocking filter and controlling a filtering operation of the deblocking filter according to the determined filter condition area value.

The present invention also provides a method for determining a filter condition area in a deblocking filter, the method comprising the steps of: storing a table containing a plurality of filter condition area values for a boundary strength calculation including at least one type value of a current macroblock and at least one of a type value of a neighbor macroblock, and storing a boundary strength calculation method per filter condition area; determining a filter condition area value corresponding to a type value of a current macroblock input to the deblocking filter and a type value of its neighbor macroblock using the table when the boundary strength calculation is performed with respect to the current macroblock input to the deblocking filter; and performing a filtering operation of the deblocking filter according to the determined filter condition area value.

A further embodiment provides a method of determining a filter condition area in a deblocking filter, the method comprising: storing a table comprising a plurality of filter condition area values for a boundary strength calculation including at least one type value of a current macroblock and at least one type value of a neighbor macroblock, storing a state diagram of areas, which indicates an area according to a type of the current macroblock and a type of the neighbor macroblock, and storing a boundary strength calculation method per filter condition area; determining a filter condition area value by determining a filter condition area value according to a type value of a current macroblock input to the deblocking filter and a type value of its neighbor macroblock using the table when the boundary strength calculation is performed with respect to the current macroblock input to the deblocking filter; and performing a filtering operation of the deblocking filter according to the determined filter condition area value.

### BRIEF DESCRIPTION OF THE DRAWINGS

The above and other objects, features and advantages of the present invention will become more apparent from the following detailed description when taken in conjunction with the accompanying drawing in which:

FIG. 1 is a diagram illustrating a general filtering calculation operation with respect to a macroblock;

FIG. 2 illustrates filter condition areas for a boundary strength calculation, which are distinguished according to a type value of a current macroblock and a type value of a neighbor macroblock;

FIG. 3A illustrates a first method for the boundary strength calculation in a conventional deblocking filter;

FIG. 3B illustrates a table of type values by area type for the first method;

FIG. 4A illustrates a second method for the boundary strength calculation in the conventional deblocking filter;

FIG. 4B illustrates a table of type values by area type for the second method;

FIG. 5 illustrates a table containing a weight per filter condition area for each boundary strength calculation in a test strip;

FIG. 6 illustrates a block diagram of a video decoder device according to an exemplary embodiment of the present invention;

FIG. 7 illustrates a table containing filter condition area values for the boundary strength calculation according to an exemplary embodiment of the present invention;

FIG. 8 illustrates a flowchart illustrating a boundary strength calculation method according to an exemplary embodiment of the present invention;

FIG. 9 illustrates a conditional expression used to perform the boundary strength calculation according to an exemplary embodiment of the present invention;

FIG. 10 illustrates a state diagram of areas, which indicates an area according to a type of a current macroblock and a type of a neighbor macroblock, according to another exemplary embodiment of the present invention;

FIG. 11 illustrates a table containing filter condition area values for the boundary strength calculation according to another exemplary embodiment of the present invention;

FIG. 12 illustrates a flowchart illustrating a boundary strength calculation method according to another exemplary embodiment of the present invention; and

FIG. 13 illustrates a conditional expression used to perform the boundary strength calculation according to another exemplary embodiment of the present invention.

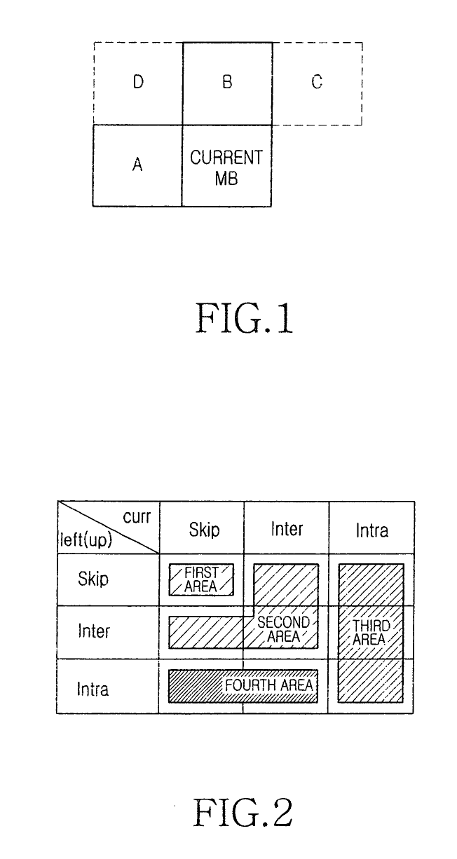

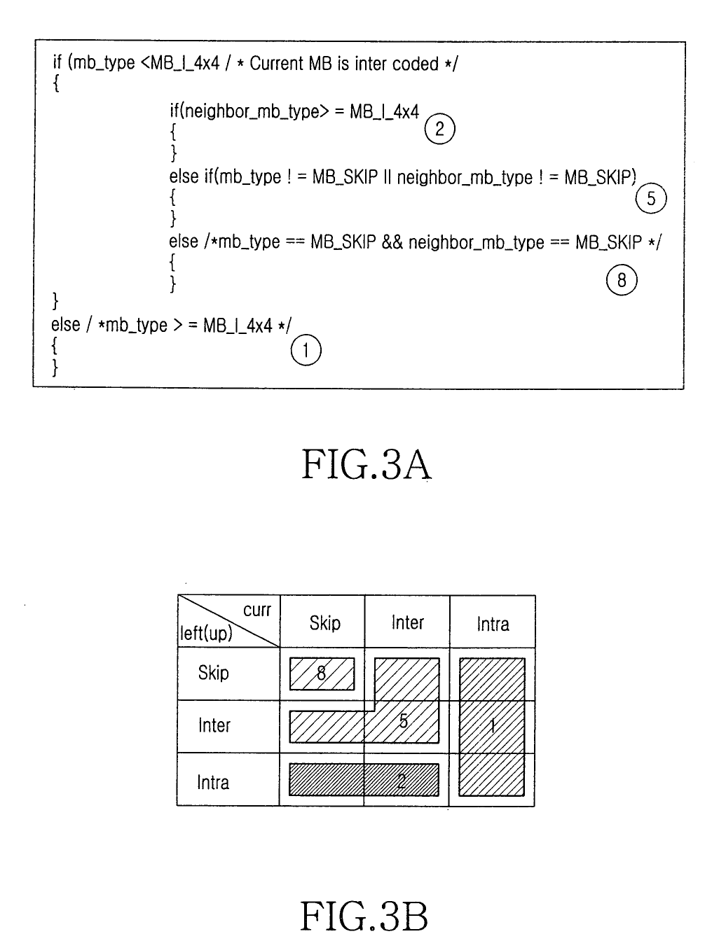

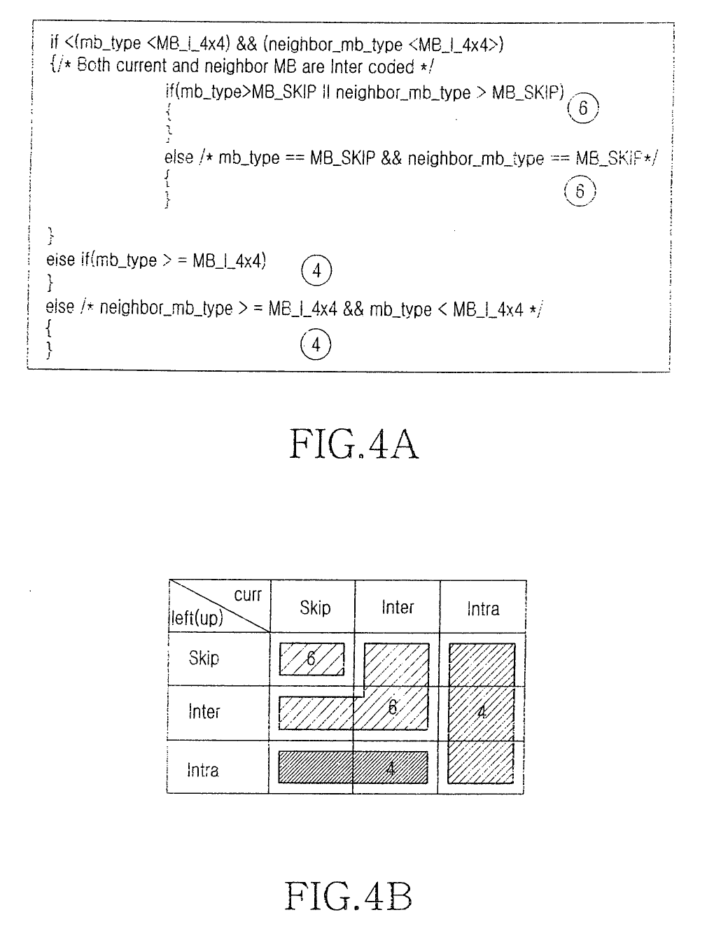

### DETAILED DESCRIPTION OF THE PRESENT INVENTION

Embodiments of the present invention will be described herein below with reference to the accompanying drawings. In the drawings, the same or similar elements are denoted by the same reference numerals even though they are depicted in different drawings. For the purposes of clarity and simplicity, well-known functions or constructions are not described in detail since they would obscure the invention in unnecessary detail.

In the present invention, two methods are provided to maximally reduce the number of cycles required for a boundary strength calculation with respect to a single macroblock in a deblocking filter.

A first provided method is used when a memory size is large enough, the method of storing a table containing all cases which can occur according to a type value of a current macroblock and a type value of a neighbor macroblock and determining an area for the boundary strength calculation using the stored table.

A second provided method is used when a memory size is not enough to store the table used in the first method, the method of storing only area information of a type value 0 corresponding to a ‘skip’ area with respect to a neighbor macroblock and type values 1˜35 corresponding to all areas with respect to a current macroblock in a memory and determining an area for the boundary strength calculation using the area information stored in the memory and a state diagram indicating an area according to types of the current macroblock and the neighbor macroblock.

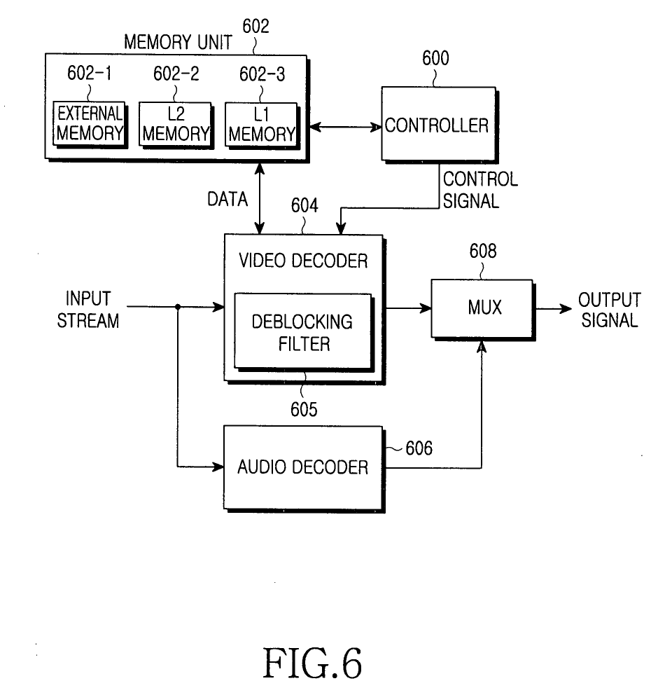

FIG. 6 is a block diagram of a video decoder device for determining an area for the boundary strength calculation according to a preferred embodiment of the present invention. Referring to FIG. 6, the video decoder device includes a video decoder 604 including a deblocking filter 605, an audio decoder 606, a memory unit 602, a multiplexer (MUX) 608, and a controller 600.

The video decoder 604 performs a decoding operation for an image output with respect to a video signal of an input stream and outputs the decoded video signal to the MUX 608. In this case, the controller 600 controls the deblocking filter 605 to performs a filtering operation in order to reduce a blocking effect occurring in every macroblock and calculate a boundary strength with respect to a current macroblock according to type values of the current macroblock and its neighbor macroblock. The audio decoder 606 performs a decoding operation for an audio output with respect to an audio signal. In the current embodiment, detailed description of the decoding operation for an image output and the decoding operation for an audio output except a configuration needed to quickly perform a deblocking operation when the controller 600 controls the deblocking filter 605 is omitted.

The MUX 608 multiplexes the decoded video and audio signals input from the video decoder 604 and the audio decoder 606 and outputs the multiplexed signal.

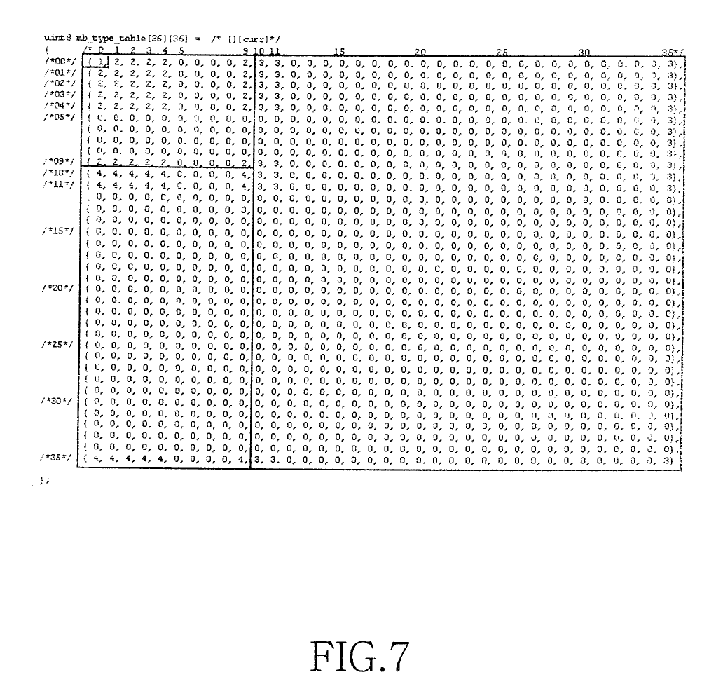

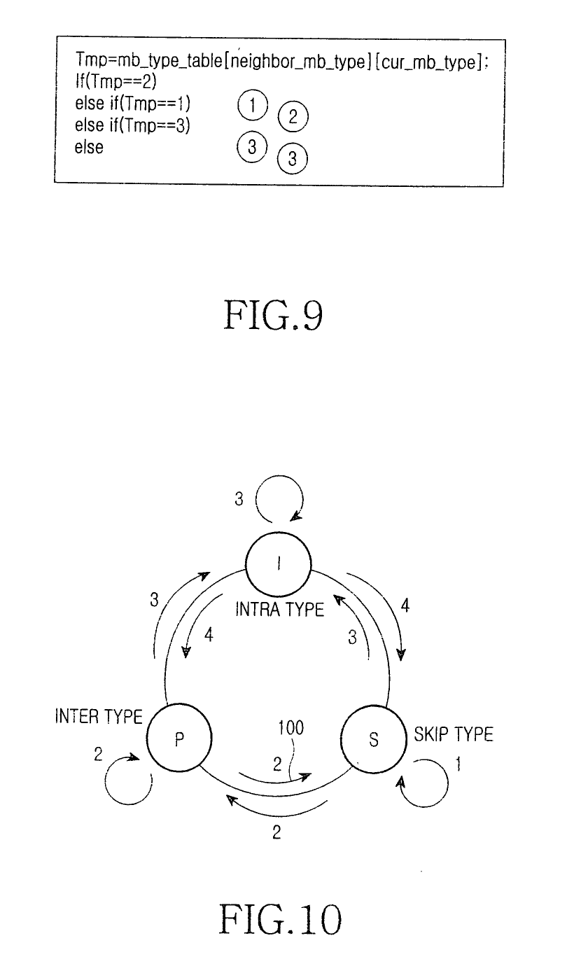

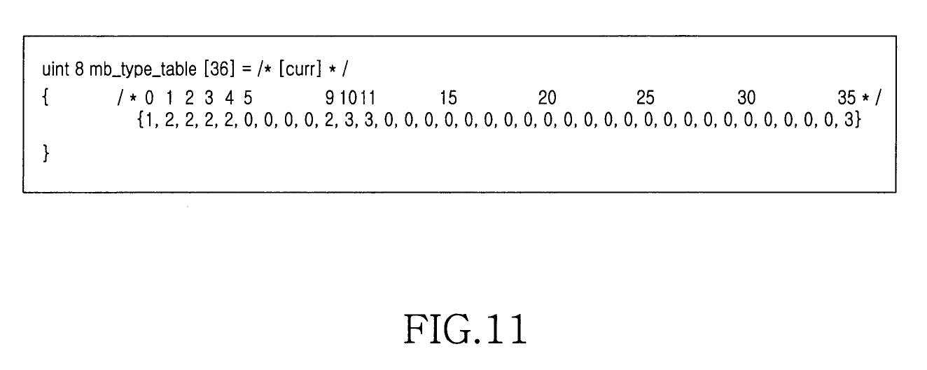

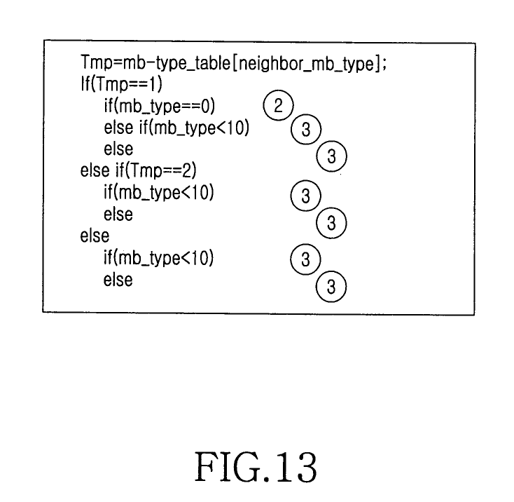

The memory unit 602 includes an external memory 602-1 and an internal memory including an L2 memory 602-2 and an L1 memory 602-3. In particular, a table illustrated in FIG. 7 (used to calculate the boundary strength using the first provided method according to a preferred embodiment of the present invention) is stored in one of the memories 602-1, 602-2, and 602-3. When the table is stored, the table may be stored in a memory nearest to the controller 600. Alternatively, a table illustrated in FIG. 11, (used to calculate the boundary strength using the second suggested method according to a preferred embodiment of the present invention) is stored in one of the memories 602-1, 602-2, and 602-3. In addition, the memory unit 602 stores a conditional expression that is to be used to calculate the boundary strength, which conditional expression is illustrated in FIGS. 9 and 13.

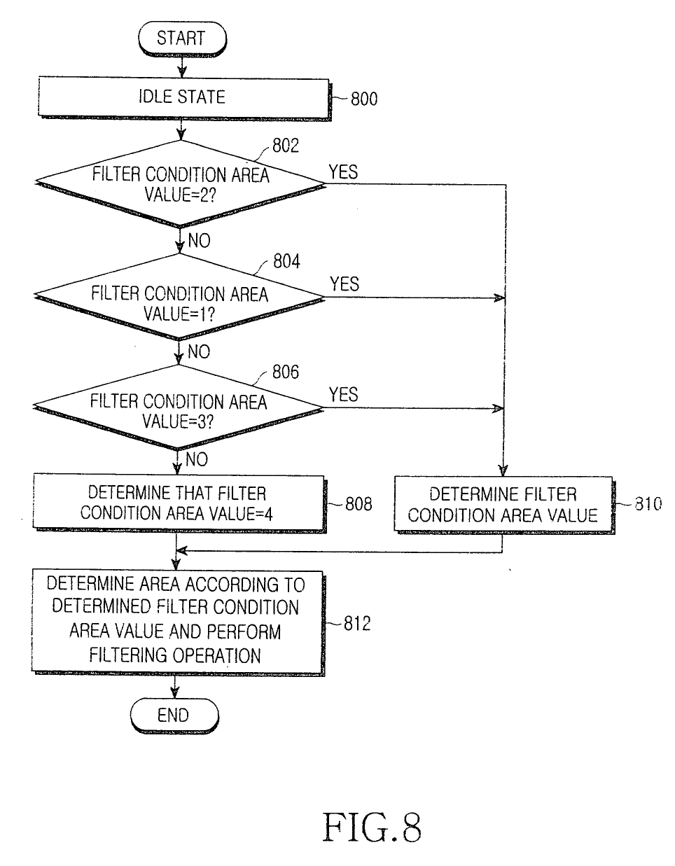

According to the first provided method, when the boundary strength with respect to a current macroblock input to the deblocking filter 605 is calculated, the controller 600 determines a filter condition area value corresponding to a type value of the current macroblock and a type value of its neighbor macroblock using the table illustrated in FIG. 7, which is stored in the memory unit 602, and controls the filtering operation of the deblocking filter 605 according to the determined filter condition area value. A detailed operation of the controller 600 according to the first provided method will be described later with reference to FIG. 8.

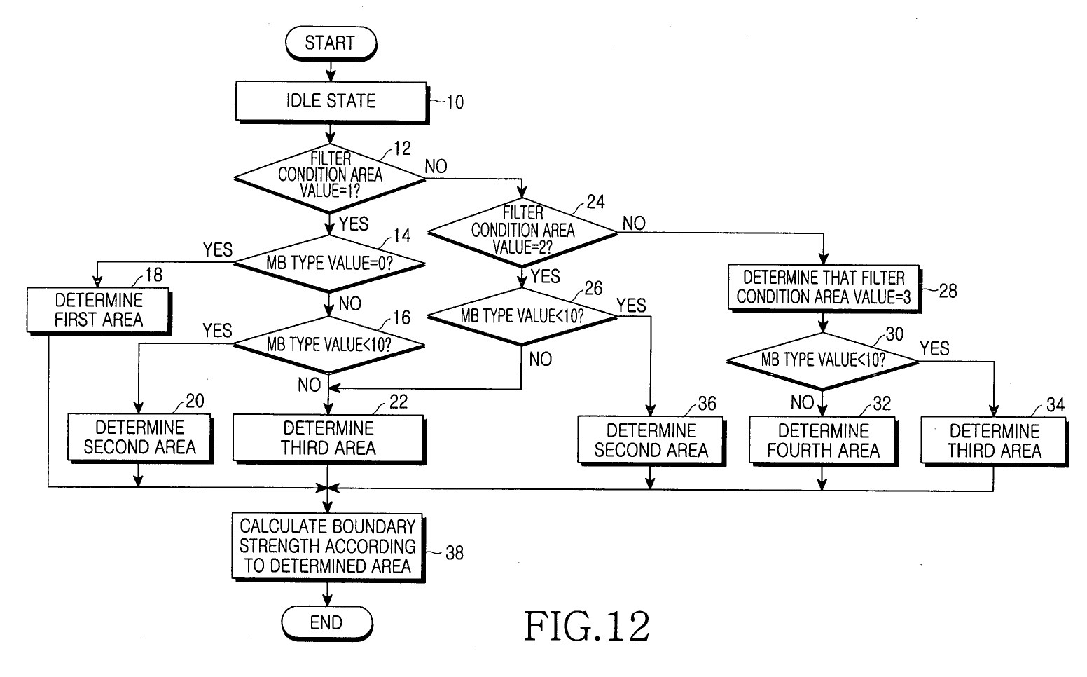

According to the second provided method, when the boundary strength with respect to a current macroblock input to the deblocking filter 605 is calculated, the controller 600 determines a filter condition area value by determining a filter condition area value according to a type value of the current macroblock and a type value of its neighbor macroblock using the table illustrated in FIG. 11, which is stored in the memory unit 602, and controls the filtering operation of the deblocking filter 605 according to the determined condition area value. A detailed operation of the controller 600 according to the second provided method will be described later with reference to FIG. 12.

The first provided method of storing a table, which contains all cases which can occur according to a type value of a current macroblock and a type value of a neighbor macroblock, in the memory unit 602 and calculating the boundary strength using the stored table, which is used when a memory size of the video decoder device illustrated in FIG. 6 is large enough, will now be described with reference to FIGS. 6 to 9.

In the first provided method, the table illustrated in FIG. 7 is stored in the memory unit 602. That is, a table is constructed by calculating, in advance, filter condition area values for calculating the boundary strength, which can occur in correspondence to type values 1˜35 of the current macroblock and type values 1˜35 of the neighbor macroblock, and the constructed table is stored in the memory unit 602.

In the case where the table is stored in the memory unit 602 of the video decoder device and the boundary strength is calculated using the first provided method, the controller 600 controls the boundary strength calculation with respect to the current macroblock according to the process illustrated in FIG. 8.

Referring to FIG. 8, the controller 600 maintains an idle state in step 800. The controller 600 determines in step 802 whether a filter condition area value for calculating the boundary strength according to type values of the current macroblock and the neighbor macroblock is 2. If it is determined in step 802 that the filter condition area value is 2, the process proceeds to step 810, or the process proceeds to step 804. In step 810, the controller 600 determines that the filter condition area value corresponds to the second area illustrated in FIG. 2, and in step 812, the controller 600 controls the deblocking filter 605 to calculate the boundary strength using a boundary strength calculation method corresponding to the second area.

In step 804, the controller 600 determines whether the filter condition area value for calculating the boundary strength according to type values of the current macroblock and the neighbor macroblock is 1. If it is determined in step 804 that the filter condition area value is 1, the process proceeds to step 810, or the process proceeds to step 806. In step 810, the controller 600 determines that the filter condition area value corresponds to the first area illustrated in FIG. 2, and in step 812, the controller 600 controls the deblocking filter 605 to calculate the boundary strength using a boundary strength calculation method corresponding to the first area.

In step 806, the controller 600 determines whether the filter condition area value for calculating the boundary strength according to the type values of the current macroblock and the neighbor macroblock is 3. If it is determined in step 806 that the filter condition area value is 3, the process proceeds to step 810, or the process proceeds to step 808. In step 810, the controller 600 determines that the filter condition area value corresponds to the third area illustrated in FIG. 2, and in step 812, the controller 600 controls the deblocking filter 605 to calculate the boundary strength using a boundary strength calculation method corresponding to the third area.

In step 808, the controller 600 determines that the filter condition area value for calculating the boundary strength according to the type values of the current macroblock and the neighbor macroblock is 4 and corresponds to the fourth area illustrated in FIG. 2, and in step 812, the controller 600 controls the deblocking filter 605 to calculate the boundary strength using a boundary strength calculation method corresponding to the fourth area.

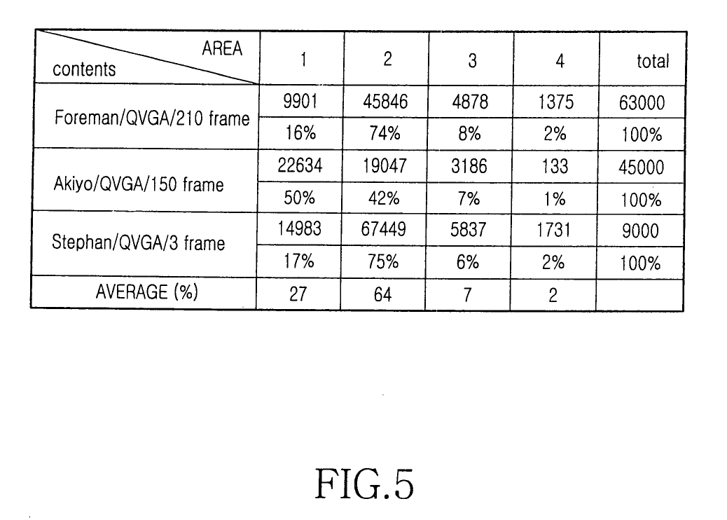

When the filter condition area value for calculating the boundary strength according to the type values of the current macroblock and the neighbor macroblock is determined in FIG. 8, an area corresponding to the filter condition area value is determined in the order of the second area, the first area, the third area, and the fourth area according to the mean weights illustrated in FIG. 5 so that the minimum number of cycles are required.

When the first provided method, according to a preferred embodiment of the present invention is used, as illustrated in FIG. 9, 1 cycle is required to determine whether the filter condition area value corresponds to the second area, and if it is determined that the filter condition area value does not correspond to the second area, 2 cycles are required to determine whether the filter condition area value corresponds to the first area. If it is determined that the filter condition area value corresponds to neither the first area nor the second area, 3 cycles are required to determine whether the filter condition area value corresponds to the third area, and if it is determined that the filter condition area value does not correspond to the first area, the second area, or the third area, it follows that the filter condition area value corresponds to the fourth area, and thus, 4 cycles are required to determine whether the filter condition area value corresponds to the fourth area.

As described above, a mean number of cycles occurring for calculating the boundary strength according to the condition comparison in the first provided method according to a preferred embodiment of the present invention can be calculated using Formula 3.

$$\begin{matrix}mean number of cycles = 0.27 * 2 + 0.64 * 1 + 0.07 * 3 + 0.02 * 3 \\ = 0.54 + 0.64 + 0.21 + 0.06 \\ = 1.45\end{matrix} \qquad ( 3 )$$

That is, as illustrated in Formula 3, when the boundary strength is calculated using the first provided method, around 1 cycle is required to calculate the boundary strength of a single macroblock.

The second provided method of storing only area information of the type value 0 corresponding to the skip area with respect to a neighbor macroblock and the type values 1˜35 corresponding to all areas with respect to a current macroblock in the memory unit 602 and calculating the boundary strength using the stored area information and a state diagram indicating an area according to types of the current macroblock and the neighbor macroblock, which is used when a memory size of the video decoder device illustrated in FIG. 6 is not enough, will now be described.

In the second provided method, the table illustrated in FIG. 11 is stored in the memory unit 602. That is, a table is constituted by calculating in advance filter condition area values for calculating the boundary strength, which can occur in correspondence to the type value 0 corresponding to the skip area with respect to the neighbor macroblock and the type values 1˜35 corresponding to all areas with respect to the current macroblock, and the constituted table is stored in the memory unit 602. In addition, the state diagram of areas indicating an area according to types of the current macroblock and the neighbor macroblock, which is illustrated in FIG. 10, is stored in the memory unit 602. Referring to FIG. 10, the area values according to types of the current macroblock and the neighbor macroblock, which are illustrated in FIG. 2, are depicted. For example, if the type of the neighbor macroblock is the inter type P and the type of the current macroblock is the skip type S, it can be determined that the current macroblock belongs to the second area referred to as reference numeral 100. For another example, if macroblocks are arranged in the order of I, P, S, P, I, I, S, S, and P, the macroblocks belong to an area in the order of 4, 2, 2, 3, 3, 4, 1, and 2. That is, if the type of the current macroblock is the skip type S, according to a type of a subsequent macroblock, the subsequent macroblock belongs to the first, second, or third area. If the type of the current macroblock is the inter type P, according to a type of a subsequent macroblock, the subsequent macroblock belongs to the second or third area. If the type of the current macroblock is the intra type I, according to a type of a subsequent macroblock, the subsequent macroblock belongs to the third or fourth area. By using this characteristic, a conditional expression illustrated in FIG. 13 can be created using the 36-byte table stored in the memory unit 602.

In the case where the table and the state diagram of areas are stored in the memory unit 602 of the video decoder device and the boundary strength is calculated using the second provided method, the controller 600 controls the boundary strength calculation with respect to the current macroblock according to the process illustrated in FIG. 12.

Referring to FIG. 12, the controller 600 maintains an idle state in step 10. The controller 600 determines in step 12 whether a filter condition area value for calculating the boundary strength of the current macroblock is 1. If it is determined in step 12 that the filter condition area value is 1, the process proceeds to step 14, or the process proceeds to step 24. In step 14, the controller 600 determines whether a type value of a neighbor macroblock is 0. If it is determined in step 14 that the type value of the neighbor macroblock is 0, the controller 600 determines in step 18 that the filter condition area value corresponds to the first area. If it is determined in step 14 that the type value of the neighbor macroblock is not 0, the controller 600 determines in step 16 whether the type value of the neighbor macroblock is less than 10. If it is determined in step 16 that the type value of the neighbor macroblock is less than 10, the controller 600 determines in step 20 that the filter condition area value corresponds to the second area. If it is determined in step 16 that the type value of the neighbor macroblock is equal to or greater than 10, the controller 600 determines in step 22 that the filter condition area value corresponds to the third area.

If it is determined in step 12 that the filter condition area value is not 1, the controller 600 determines in step 24 whether the filter condition area value is 2. If it is determined in step 24 that the filter condition area value is 2, the process proceeds to step 26, or the process proceeds to step 28. In step 26, the controller 600 determines whether the type value of the neighbor macroblock is less than 10. If it is determined in step 26 that the type value of the neighbor macroblock is less than 10, the controller 600 determines in step 36 that the filter condition area value corresponds to the second area.

If it is determined in step 26 that the type value of the neighbor macroblock is equal to or greater than 10, the controller 600 determines in step 22 that the filter condition area value corresponds to the third area.

If it is determined in step 24 that the filter condition area value is neither 1 nor 2, in step 28, the controller 600 determines that the filter condition area value is 3. The controller 600 determines in step 30 whether the type value of the neighbor macroblock is less than 10. If it is determined in step 30 that the type value of the neighbor macroblock is less than 10, the controller 600 determines in step 34 that the filter condition area value corresponds to the third area. If it is determined in step 30 that the type value of the neighbor macroblock is equal to or greater than 10, the controller 600 determines in step 32 that the filter condition area value corresponds to the fourth area.

After step 18, 20, 22, 32, 34, or 36 is performed, in step 38, the controller 600 controls the deblocking filter 605 to calculate the boundary strength using a boundary strength calculation method corresponding to the area determined in a relevant step.

As described above, when the second provided method according to a preferred embodiment of the present invention is used, as illustrated in FIG. 13, 2 cycles are required to determine whether the filter condition area value corresponds to the first area, 3 cycles are required to determine whether the filter condition area value corresponds to the second area and the third area, or the fourth area, and 3 cycles are required to determine whether the filter condition area value corresponds to the third area.

As described above, a mean number of cycles occurring for calculating the boundary strength according to the condition comparison in the second provided method according to a preferred embodiment of the present invention can be calculated using Formula 4. Here, the mean number of cycles can be predicted according to the weights of areas illustrated in FIG. 5.

$$\begin{matrix}mean number of cycles = 0.27 * 2 + 0.64 * 3 + 0.07 * 3 + 0.02 * 3 \\ = 0.54 + 1.92 + 0.21 + 0.06 \\ = 2.73\end{matrix} \qquad ( 4 )$$

That is, as illustrated in Formula 4, when the boundary strength is calculated using the second provided method, 2.73 cycles are required to calculate the boundary strength of a single macroblock.

As described above, according to the present invention, when a deblocking filter calculates a boundary strength using a first or second suggested method, 1.45 or 2.73 cycles are required on average, thereby reducing the number of cycles compared to around 5 cycles required for the boundary strength calculation in an existing deblocking filter. Accordingly, when an image is processed, a decoding process can be performed more quickly.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. An apparatus for determining a filter condition area in a deblocking filter, comprising:
a memory unit for storing a table containing at least one filter condition area value for a boundary strength calculation of at least one filter condition area, each said at least one value corresponding to each of a type value of a current macroblock and a type value of a neighbor macroblock, and storing a boundary strength calculation method for said at least one filter condition area;
the deblocking filter further comprising a boundary strength calculation module to perform a boundary strength calculation according to the at least one filter condition area with respect to an input macroblock using the table of the memory unit; and
a controller to determine a filter condition area value of the table that corresponds to a type value of a current macroblock input to the deblocking filter and a type value of a neighbor macroblock using the table when the boundary strength calculation is performed with respect to the current macroblock input to the deblocking filter and to control a filtering operation of the deblocking filter according to the determined filter condition area value.

2. The apparatus of claim 1, wherein the memory unit is an external memory.

3. An apparatus for determining a filter condition area in a deblocking filter, comprising:
a memory unit for storing a table containing at least one filter condition area value for a boundary strength calculation for at least one filter condition area, each said at least one filter condition area value corresponding to each of all type values of a current macroblock and at least one of all type values of a neighbor macroblock, for storing a state diagram of areas, which indicates an area according to a type of the current macroblock and a type of the neighbor macroblock, and for storing a boundary strength calculation method for each said at least one filter condition area;
the deblocking filter further comprising a boundary strength calculation module for performing a boundary strength calculation with respect to an input macroblock using the table of the memory unit; and
a controller to determine a filter condition area value by determining a filter condition area value of the table according to a type value of a current macroblock input to the deblocking filter and a type value of its neighbor macroblock using the table when the boundary strength calculation is performed with respect to the current macroblock input to the deblocking filter and to control a filtering operation of the deblocking filter according to the determined filter condition area value.

4. The apparatus of claim 3, wherein the memory unit is an external memory.

5. A method for determining a filter condition area in a deblocking filter, the method comprising the steps of:
for at least one filter condition areas, storing a table containing at least one filter condition area value for a boundary strength calculation, said at least one filter condition area value corresponding to one of the values selected from the group consisting of each of a type value of a current macroblock and a type value of a neighbor macroblock,;
storing a boundary strength calculation method for the at least one filter condition area;
determining a filter condition area value corresponding to a type value of a current macroblock input to the deblocking filter and a type value of its neighbor macroblock using the table when the boundary strength calculation is performed with respect to the current macroblock input to the deblocking filter; and
performing a filtering operation of the deblocking filter according to the determined filter condition area value.

6. The method of claim 5, wherein the step of determining the filter condition area value corresponding to the type value of the current macroblock and the type value of its neighbor macroblock further comprises the steps of determining a filter condition area value by comparing each filter condition area value in the order of a filter condition area occupied more frequently by macroblocks on average, among filter condition area values to the filter condition area value corresponding to the type value of the current macroblock and the type value of its neighbor macroblock wherein a filter condition area is determined using a minimum number of comparison cycles.

7. A method of determining a filter condition area in a deblocking filter, comprising:
for at least one filter condition area, storing a table containing a filter condition area value for a boundary strength calculation, said value corresponding to each of all type values of a current macroblock and at least one of all type values of a neighbor macroblock;
storing a state diagram of areas, which indicates a filter condition area according to a type of the current macroblock and a type of the neighbor macroblock;
storing a boundary strength calculation method per filter condition area;
determining a filter condition area value according to a type value of a current macroblock input to the deblocking filter and a type value of its neighbor macroblock using the table when the boundary strength calculation is performed with respect to the current macroblock input to the deblocking filter; and
performing a filtering operation of the deblocking filter according to the determined filter condition area value.
